(19) United States
(12) Patent Application Publication
(10) Pub. No.: US 2016/0321833 A1
(43) Pub. Date: Nov. 3, 2016

(54) METHOD AND APPARATUS FOR GENERATING MOVING PHOTOGRAPH BASED ON MOVING EFFECT

(71) Applicant: SEERSLAB, INC., Seoul (KR)

(72) Inventors: Jin Wook CHONG, Seoul (KR); Jae Cheol KIM, Seoul (KR)

(21) Appl. No.: 14/788,619

(22) Filed: Jun. 30, 2015

(30) Foreign Application Priority Data
Apr. 29, 2015 (KR) 10-2015-0060862

(51) Int. Cl. G06T 13/80

(52) U.S. Cl. CPC G06T 13/80

(57) ABSTRACT

An apparatus and method for generating a moving photograph are disclosed herein. The apparatus for generating a moving photograph includes a display unit, an application unit, and a generation unit. The display unit displays a subject photographed by a camera. When any one of a plurality of moving effects is selected by a user, the application unit applies the selected effect to the displayed subject. The generation unit captures the subject and the applied effect in compliance with a photographing command, and generates a moving photograph in which the subject is maintained in a captured state and only the applied effect is moving.

### CROSS-REFERENCE TO RELATED APPLICATION

This application claims the benefit of Korean Patent Application No. 10-2015-0060862, filed Apr. 29, 2015, which is hereby incorporated by reference herein in its entirety.

### BACKGROUND

1. Technical Field

The present disclosure relates generally to the generation of a moving photograph and, more particularly, to a method and apparatus for generating a moving photograph, which are capable of generating a moving photograph based on a moving effect by applying the moving effect to a subject.

2. Description of the Related Art

The concept of cinemagraphs was first introduced by the Harry Potter series of J. K. rolling in 1997, and then cinemagraphs were popularized by photographer Jamie Beck and graphic artist Kevin Burg, who were working in New York, in 2011. Cinemagraphs may be viewed as an intermediate form between photographs and moving images, and are characterized in that only part of a photograph is continuously played back.

Cinemagraphs are designed to continuously play back part of a photograph so that only part of the photograph moves. A plurality of photographs, such as a photograph in which part of a subject is stopped and a photograph in which the movement of part of the subject has occurred, is required in order to infinitely play back part of a photograph, and a moving photograph is generated by editing the plurality of photographs.

That is, in the case of cinemagraphs, a moving photograph is generated by moving only a specific object included in a subject without using an additional effect.

However, cinemagraphs are problematic in that the generation of moving photographs is complicated and persons lacking relevant expert knowledge cannot generate moving photographs because editing is performed using a plurality of photographs of a subject to allow only a specific object to move and then the result thereof is applied.

### SUMMARY

Embodiments of the present invention provide a method and apparatus for generating a moving photograph, which are capable of generating a moving photograph by applying a moving effect to a subject.

More specifically, embodiments of the present invention provide a method and apparatus for generating a moving photograph, which are capable of generating a moving photograph by moving only an effect while maintaining a subject in a captured state, with respect to a capture image of the subject to which the moving effect has been applied.

In accordance with an aspect of the present invention, there is provided a method of generating a moving photograph, including: displaying a subject photographed by a camera; when any one of a plurality of moving effects is selected by a user, applying the selected effect to the displayed subject; and capturing the subject and the applied effect in compliance with a photographing command, and generating a moving photograph in which the subject is maintained in a captured state and only the applied effect is moving.

Generating the moving photograph may include: capturing the subject and the applied effect at a time at which the photographing command is received, generating a capture image, and displaying the generated capture image; and when a button formed in a partial area of the displayed capture image is selected by the user, generating the moving photograph from the capture image.

The method may further include, when a storage button configured to store the displayed capture image is selected by the user, storing the capture image without generating the moving photograph.

The method may further include: displaying the generated moving photograph; and when a storage button configured to store the generated moving photograph is selected by the user, storing the moving photograph in a Graphics Interchange Format (GIF) file.

Applying the selected effect to the displayed subject may include determining the location of the subject to which the selected effect will be applied based on an object included in the subject, and applying the selected effect to the determined location of application.

The capture image and the moving photograph may be shared via at least one predetermined application.

In accordance with another aspect of the present invention, there is provided a method of generating a moving photograph, including: displaying any selected one of a plurality of stored photographs; when any one of a plurality of moving effects is selected by a user, applying the selected effect to the selected photograph; and generating a moving photograph in which the applied effect is moving in the selected photograph.

Applying the selected effect to the selected photograph may include determining the location of the selected photograph to which the selected effect will be applied based on an object included in the selected photograph, and applying the selected effect to the determined location of application.

In accordance with still another aspect of the present invention, there is provided an apparatus for generating a moving photograph, including: a display unit configured to display a subject photographed by a camera; an application unit configured to, when any one of a plurality of moving effects is selected by a user, apply the selected effect to the displayed subject; and a generation unit configured to capture the subject and the applied effect in compliance with a photographing command, and to generate a moving photograph in which the subject is maintained in a captured state and only the applied effect is moving.

The generation unit may be further configured to capture the subject and the applied effect at a time at which the photographing command is received, generate a capture image, and provide the generated capture image to the display unit so that the generated capture image can be displayed, and to, when a button formed in a partial area of the displayed capture image is selected by the user, generate the moving photograph from the capture image.

The apparatus may further include a storage unit configured to, when a storage button configured to store the generated moving photograph is selected by the user in a state in which the generated moving photograph has been displayed on the display unit, store the moving photograph in a Graphics Interchange Format (GIF) file.

The application unit may be further configured to determine the location of the subject to which the selected effect will be applied based on an object included in the subject and to apply the selected effect to the determined location of application.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exemplary diagram illustrating the present invention;

FIG. 2 is an operation flowchart showing a method generating a moving photograph according to an embodiment of the present invention;

FIGS. 3 to 6 are exemplary diagrams illustrating a method of generating a moving photograph according to an embodiment of the present invention; and

FIG. 7 is a diagram showing the configuration of an apparatus for generating a moving photograph according to an embodiment of the present invention.

### DETAILED DESCRIPTION

Embodiments of the present invention will be described in detail below with reference to the accompanying drawings. However, the present invention is not limited or restricted by these embodiments. Furthermore, throughout the drawings, the same reference symbols designate the same components.

The present invention is intended to generate a moving photograph based on a moving effect, and is characterized by applying a moving effect to a subject and then generating a moving photograph in which the subject is maintained in a captured state and only the moving effect is moving.

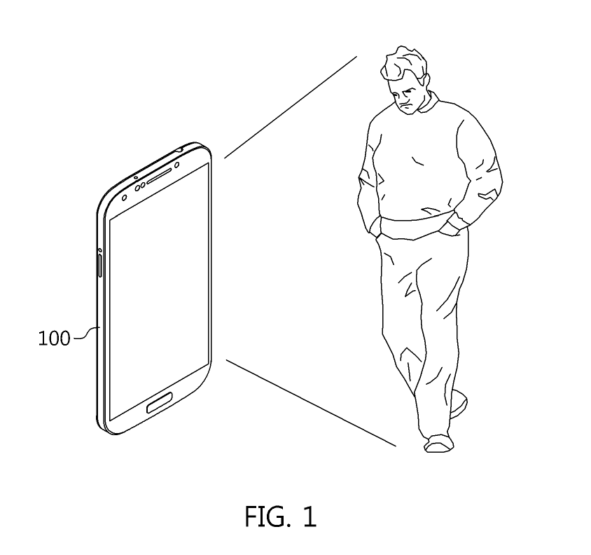

FIG. 1 is an exemplary diagram illustrating the present invention.

As shown in FIG. 1, the present invention may be applied to a device 100 equipped with a camera, such as a smart phone. The present invention is installed on a smart phone in the form of an application. When a subject is photographed using a camera, a moving effect selected by a user is applied to the subject, i.e., a photographing target, and a moving photograph to which the moving effect has been applied is generated.

In this case, the subject may include various objects, such as a human, a building, an automobile, etc. The location at which the moving effect selected by the user is applied may be determined by the information of the selected moving effect and object information included in the subject to be photographed.

In the following, for ease of description, the present invention is described as being performed in a smart phone equipped with a camera. It will be apparent to those skilled in the art that the present invention is not limited to the smart phone but may be applied to all devices on which the present invention can be installed.

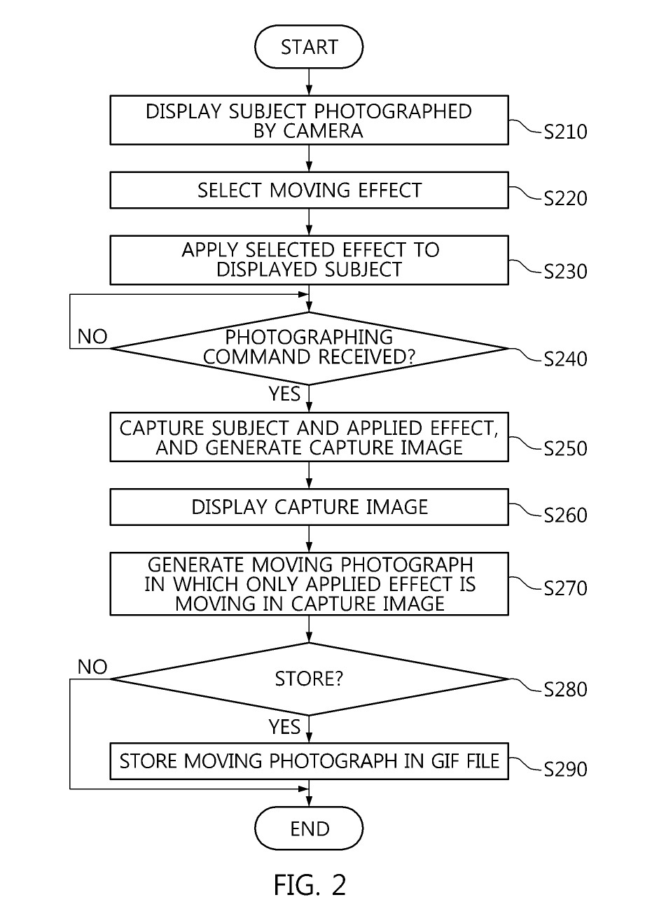

FIG. 2 is an operation flowchart showing a method generating a moving photograph according to an embodiment of the present invention.

Referring to FIG. 2, in the method of generating a moving photograph according to the present embodiment, an application related to the present invention is executed, and a subject photographed by the camera of a device on which the application has been installed, for example, a subject including an object, such as an automobile, scenery, a human or the like, is displayed on a screen at step S210.

Various filter functions may be applied to the subject displayed at step S210 in response to a user's selection, and the various functions of the camera configured to photograph a subject may be applied to the subject displayed at step S210.

Once the subject has been displayed on the screen at step S210, a moving effect or moving sticker to be applied to the displayed subject is selected based on a user's input at step S220.

The moving effect or moving sticker that is applied to the subject is provided by the application that provides the method of the present invention. The moving effect may include various effects, such as a moving rabbit ear effect, a moving cloud effect, a moving heart effect, a rising heart balloon effect, a moving butterfly effect, etc.

Once the moving effect to be applied has been selected in response to the user's input or selection at step S220, the selected moving effect is applied to the subject displayed on the screen at step S230, and it is determined whether a photographing command based on a user's input has been received at step S240.

At step S230, the location of the subject to which the moving effect selected by the user will be applied may be determined based on the object included in the subject photographed by the camera, and then the selected moving effect may be applied to the determined location of application. For example, if the moving effect selected by the user is an effect in which a rabbit's moving ears are applied to a human's head, the location of the human's head is acquired from the photographed subject, and then the rabbit's ears are applied to the acquired location of the head.

At step S230, when a movement occurs in the subject displayed on the screen due to the movement of the user who is photographing the subject, the location of the effect to be applied may be also changed in accordance with the occurring movement. It will be apparent that when the effect selected by the user is an effect that is not applied to the subject displayed on the screen, the effect may not be applied to the subject, and the user may be notified that the effect in question is an effect that is not applied to the subject.

If, as a result of the determination at step S240, it is determined that a photographing command has been received in response to the user's input, the subject displayed on the screen and the moving effect applied to the subject are captured and then a capture image is generated at step S250, and the generated capture image is displayed on the screen at step S260.

In this case, the capture image generated at step S250 refers to an image in which both the subject and the moving effect have been captured. When a storage button present on the screen is pressed by the user, the generated capture image may be stored. The generated or stored capture image may be shared via at least one predetermined application, for example, a messenger service such as LINE, KakaoTalk or the like, BAND, a social network service (SNS), or the like.

A moving photograph in which in the capture image displayed at step S260, the subject is maintained in a capture state and only the applied moving effect is moving is generated at step S270.

In this case, at step S270, when a moving photograph generation button formed in a partial area of the capture image displayed at step S260 or a partial area of the screen is pressed or selected by the user, a moving photograph that enables only the applied moving effect to move in the capture image may be generated.

Once the moving photograph has been generated at step S270, whether to store the generated moving photograph is determined based on the user's input at step S280. When the storage button is selected by the user's input, the generated moving photograph is stored in a file, for example, a Graphics Interchange Format (GIF) file, at step S290.

It will be apparent that the moving photograph generated at step S270 and the moving photograph stored at S280 may be shared via at least one predetermined application, for example, a messenger service such as LINE, KakaoTalk or the like, BAND, an SNS, or the like.

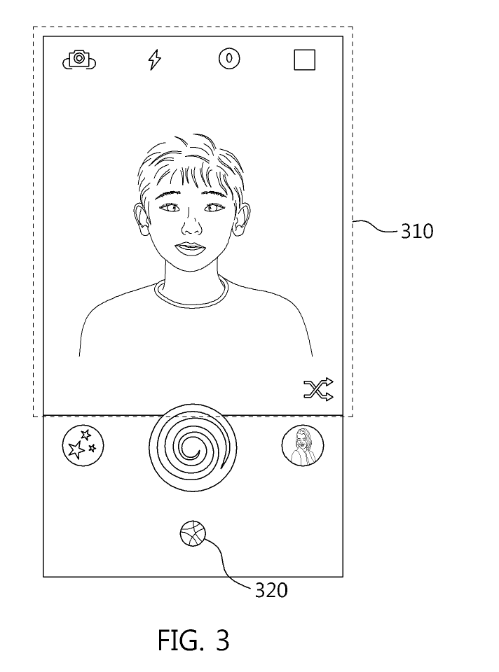

A method of generating a moving photograph according to an embodiment of the present invention, including the above-described steps, is described in detail below with reference to FIGS. 3 to 6.

FIGS. 3 to 6 are exemplary diagrams illustrating the method of generating a moving photograph according to the present embodiment.

Referring to FIGS. 3 to 6, in the method of generating a moving photograph according to the present embodiment, when an application that performs the present invention is executed by a user, the subject photographed by a camera provided in or connected to a device on which an application has been installed is displayed on a partial area 310 of a screen, as in an example shown in FIG. 3.

In this case, a changing means or setting means capable of changing or setting various functions related to the photographing of the camera may be also displayed on the partial area of the screen on which the subject is displayed. A user interface used for the changing of photographing mode, the checking of a stored image, and the selection of an effect to be applied may be displayed on a partial area of the screen.

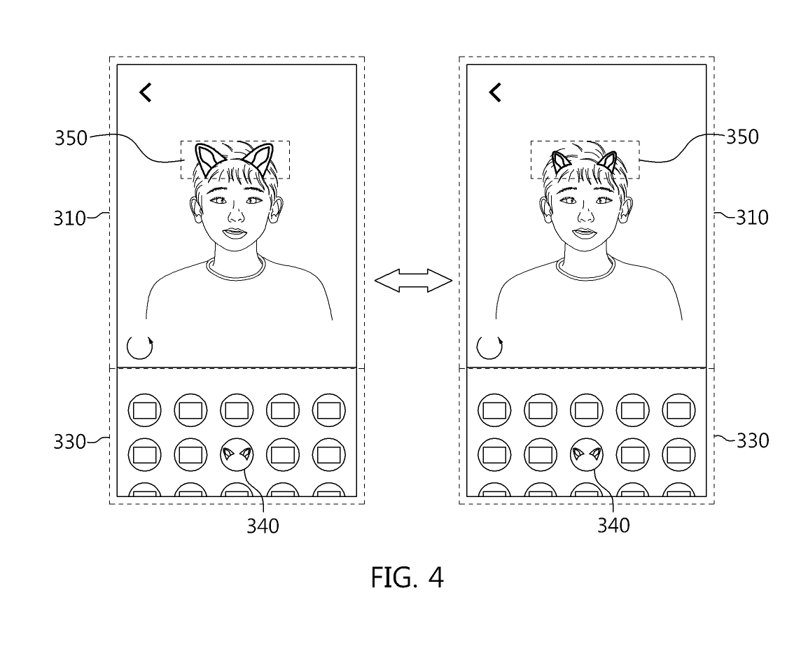

In FIG. 3, when an effect selection button 320 that enables a user to select a moving effect is selected by the user, various applicable moving effects or stickers 330 are displayed in a partial area of the screen, as in an example shown in FIG. 4.

Once any one of the various moving effects provided by the application, for example, the moving rabbit ears 340 in FIG. 4, has been selected, the selected rabbit ears 340 search for the target object of the subject (in this case, a human), acquire the location of the human's head, and apply selected rabbit ears 350 to the acquired location of the head.

The rabbit ears 350 applied to the subject repeatedly moves from a form in which a rabbit' ears have been raised, such as that shown in the left view of FIG. 4, to a form in which the rabbit's ears have been lowered, such as that shown in the right view of FIG. 4. It will be apparent that the movement of the rabbit's ears is not limited to the movement between a form in which a rabbit' ears have been raised and a form in which the rabbit's ears have been bent, but may be the movement in which the rabbit's ears move laterally.

As described above, once the rabbit ear effect 340 has been selected by the user in FIG. 4, the moving rabbit ear 350 is applied to the location of the human's head that is being photographed by the camera, and a form in which the rabbit's moving ears have been attached to the human's head is displayed on the screen. In this case, when the movement of the human occurs in the screen, the selected rabbit's ears acquire the location of the human's head in real time, and are applied to the acquired location of the human's head in real time.

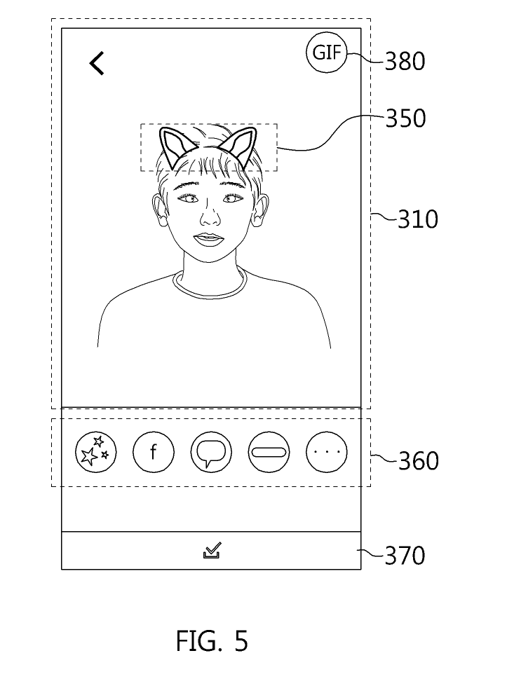

When a photographing command is received in response to a user's input in the state in which the moving effect has been applied to the subject, as shown in FIG. 4, the image displayed in the partial area 310 of the screen is captured at the time at which the photographing command is received, and a capture image is generated, as in an example shown in FIG. 5.

In this case, since the generated capture image is an image captured in the state of being displayed on the screen at the time at which the photographing command is received, the rabbit's moving ears are also in the state of being captured without movement.

Once the capture image has been generated, the capture image is displayed on the screen, a button 380 configured to generate a moving photograph, for example, a GIF button, is generated in a partial area of the capture image, applications 360 having the sharing function of sharing the capture image are displayed on a partial area of the screen, and a storage button 370 configured to store the capture image is displayed, as shown in FIG. 5.

Once the storage button 370 has been pressed by the user, the capture image captured on the screen is stored in a photograph file with a specific format, such as a JPG file.

Furthermore, when any one of the sharing applications is selected by the user, the capture image may be shared with another person via the selected application.

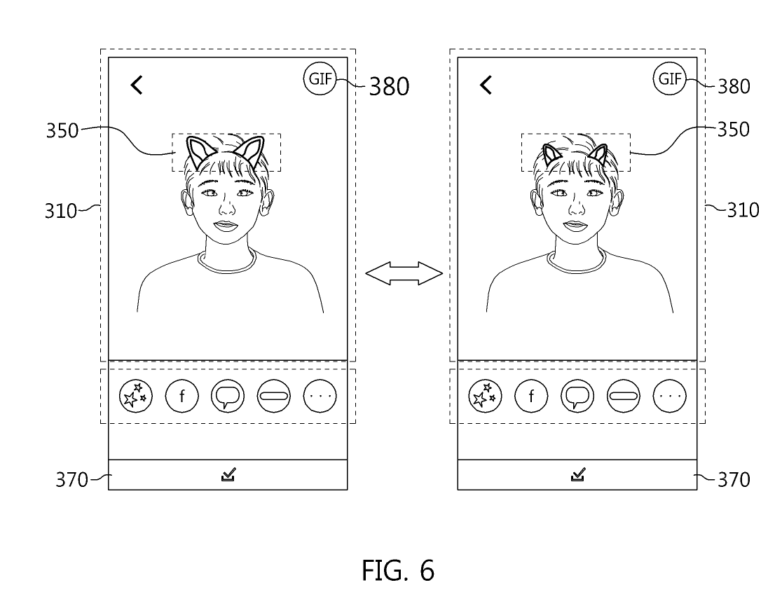

In contrast, when the user selects the GIF button 380 configured to generate a moving photograph in FIG. 5, the GIF button 380 is activated, and the subject is maintained in the captured state and the applied moving effect is realized (in this case, only the rabbit's moving ears move at a captured location) in the capture image. Accordingly, the rabbit's ears repeatedly move from a form in which the rabbit's ears have been raised, such as that shown in the left view of FIG. 6, to a form in which the rabbit's ears have been bent, such as that shown in the right view of FIG. 6, as shown in FIG. 6.

In this case, the generated moving photograph is displayed in the partial area of the screen, thereby enabling the user to determine whether to store or share the generated moving photograph.

In the same manner as the capture image, when a moving photograph is generated, the applications 360 having the sharing function of sharing the moving photograph are displayed in a partial area of the screen, and the storage button 370 configured to store the moving photograph is displayed.

When the storage button 370 is pressed by the user, the moving photograph generated on the screen is stored in a file with a specific format, for example, a GIF file.

Furthermore, when any one of the sharing applications is selected by the user, the moving photograph may be shared with another person via the selected application.

The buttons provided by the user interface of FIGS. 3 to 6 are not limited to specific location. The locations and functions of the buttons may be determined by a provider who provides the service of the present invention.

As described above, the method of generating a moving photograph according to the present embodiment generates a moving photograph including a moving effect by applying the moving effect to a subject, and thus various moving effects may be applied to a subject, thereby arousing a user's interest and amusement via the various moving effects.

Furthermore, the method of generating a moving photograph according to the present embodiment may generate a moving photograph by applying only various types of moving effects, thereby enabling any general user lacking relevant expert knowledge to generate a moving photograph.

Furthermore, the method of generating a moving photograph according to the present invention may not only generate a moving photograph by applying a moving effect when photographing a subject, but may also generate a moving photograph by applying a moving effect to a stored photograph. That is, a method according to another embodiment of the present invention selects any one of the stored photographs, displays the selected photograph on a screen, and applies a moving effect to the selected photograph by selecting one of a plurality of moving effects to be applied, thereby generating a moving photograph including the applied moving effect. Additionally, the above-described configurations, including the configuration of determining a location of a photograph to which a moving effect will be applied and the configuration of storing a moving photograph, may be also applied.

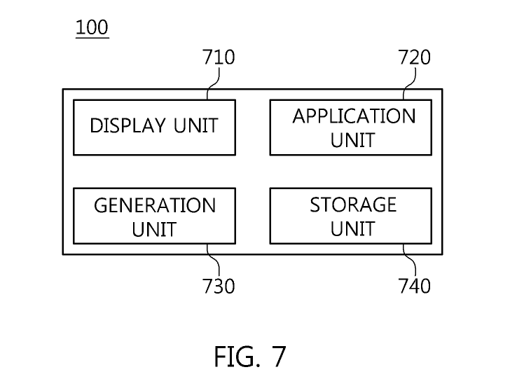

FIG. 7 shows the configuration of an apparatus for generating a moving photograph according to an embodiment of the present invention, and shows an apparatus that performs the method of generating a moving photograph described with reference to FIGS. 2 to 6.

In this case, the apparatus for generating a moving photograph may be configured to be included in any device equipped with a camera.

Referring to FIG. 7, the apparatus 100 for generating a moving photograph according to this embodiment includes a display unit 710, an application unit 720, a generation unit 730, and a storage unit 740.

The display unit 710 is a means for displaying all data related to the present invention, including a subject photographed by the camera of the apparatus, a capture image captured by the camera, a moving photograph generated using the captured capture image, a user interface, etc.

In this case, the display unit 710 is a means for displaying data, and may be, for example, a touch screen provided in a smart phone.

The application unit 720, when any one of various moving effects applicable to a subject photographed and displayed by the camera is selected by a user, applies the selected moving effect to the subject.

In this case, the application unit 720 may determine the location of a subject to which the moving effect selected by the user will be applied based on an object included in the subject photographed by the camera, and may apply the selected moving effect to the determined location of application. For example, when the moving effect selected by the user is an effect in which a rabbit's moving ears are applied to a human's head, the application unit 720 may acquire the location of the human's head from the photographed subject, and may apply the rabbit's moving ears to the acquired location of the head.

In this case, when a movement occurs in the subject displayed on the screen due to the movement of the user who photographs the subject, the application unit 720 may change and apply the location of the effect to be applied in accordance with the occurring movement.

The generation unit 730 captures the subject and the applied moving effect in compliance with a photographing command issued by the user, and generates a moving photograph in which the subject is maintained in a captured state and only the applied effect is moving.

In this case, the generation unit 730 captures the subject and the applied effect at the time at which the photographing command is received, generates a capture image, provides the generated capture image to the display unit 710 so that the generated capture image may be displayed, and may generate a moving photograph from the capture image when a button formed in a partial area of the displayed capture image is selected by the user.

The capture image and the moving photograph generated by the generation unit 730 may be shared with another person via at least one predetermined application.

The storage unit 740, when the storage button configured to store capture image and provided via the user interface is selected by the user, stores the capture image without generating a moving photograph, and, when the storage button configured to store a moving photograph is selected by the user in the state in which a moving photograph has been generated and displayed, stores the moving photograph in a GIF file.

In this case, the storage unit 740 may store all data required for the performance of the present invention, such as an algorithm, an application, various effect data, a capture image, a moving photograph, etc.

The apparatuses and the components described above may be implemented using hardware components, software components, or combinations thereof. For example, the apparatuses and the components described in conjunction with the embodiments may be implemented using one or more general-purpose or special-purpose computers, such as a processor, a controller, an arithmetic logic unit (ALU), a digital signal processor, a microcomputer, a field programmable array (FPA), a programmable logic unit (PLU), a microprocessor, or any other device capable of responding to and executing instructions. The processing device may run an operating system (OS) and one or more software applications that run on the OS. The processing device also may access, store, manipulate, process, and create data in response to the execution of the software. Although a single processing device has been described as being used for purpose of simplicity, one skilled in the art will appreciate that a processing device may include multiple processing elements and multiple types of processing elements. For example, a processing device may include multiple processors, or a processor and a controller. In addition, different processing configurations, such as parallel processors, may be used.

The software may include a computer program, program code, instructions, or combinations thereof. The software may independently or collectively instruct or configure the processing device so that the processing device operates as desired. The software and the data may be embodied permanently or temporarily in any type of machine, component, physical or virtual equipment, computer storage medium or device, or in signal waves so that the software and the data can provide instructions or data to or can be interpreted by the processing device. The software also may be distributed over network coupled computer systems so that the software is stored and executed in a distributed fashion. In particular, the software and data may be stored by one or more computer readable recording mediums.

The methods according to the embodiments of the present invention may be implemented as a program or a smart phone app that can be executed by various computer means. In this case, the program or smart phone app may be recorded on a computer-readable storage medium. The computer-readable storage medium may include program instructions, data files, and data structures solely or in combination. Program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as compact disk (CD)-read only memory (ROM) and a digital versatile disk (DVD), magneto-optical media, such as a floptical disk, ROM, random access memory (RAM), and flash memory. Examples of the program instructions include machine code, such as code created by a compiler, and high-level language code executable by a computer using an interpreter. The hardware devices may be configured to operate as one or more software modules in order to perform the operation of the present invention, and the vice versa.

The embodiments of the present invention can generate a moving photograph by applying a moving effect to a subject and moving only an effect while maintaining the subject in a captured state, thereby enabling a user to generate a moving photograph without requiring relevant expert knowledge.

The embodiments of the present invention can apply various types of moving effects to subjects, thereby enabling a user to generate moving photographs having various effects.

The embodiments of the present invention can be applied to a device equipped with a camera, such as a smart phone, and enable an application related to the present invention to be installed on the smart phone, so that moving photographs having various effects can be provided to a user who uses the smart phone, thereby providing various types of amusement to the user.

Although the present invention has been described in connection with the limited embodiments and drawings, those skilled in the art may make various changes and modifications based on the above description. For example, even when the described technology is performed in an order different from the described one, even when the components of the described system, structure, apparatus or circuit are coupled or combined with each other in a manner different from the described one, and/or even when a component of the described system, structure, apparatus or circuit is replaced with another component or its equivalent, appropriate results may be achieved.

Therefore, other implementations, other embodiments, and equivalents to the attached claims also fall within the scope of the attached claims.

What is claimed is:

1. A method of generating a moving photograph, comprising:
displaying a subject photographed by a camera;
when any one of a plurality of moving effects is selected by a user, applying the selected effect to the displayed subject; and
capturing the subject and the applied effect in compliance with a photographing command, and generating a moving photograph in which the subject is maintained in a captured state and only the applied effect is moving.

2. The method of claim 1, wherein generating the moving photograph comprises:
capturing the subject and the applied effect at a time at which the photographing command is received, generating a capture image, and displaying the generated capture image; and
when a button formed in a partial area of the displayed capture image is selected by the user, generating the moving photograph from the capture image.

3. The method of claim 1, further comprising, when a storage button configured to store the displayed capture image is selected by the user, storing the capture image without generating the moving photograph.

4. The method of claim 1, further comprising:
displaying the generated moving photograph; and
when a storage button configured to store the generated moving photograph is selected by the user, storing the moving photograph in a Graphics Interchange Format (GIF) file.

5. The method of claim 1, wherein applying the selected effect to the displayed subject comprises determining a location of the subject to which the selected effect will be applied based on an object included in the subject, and applying the selected effect to the determined location of application.

6. The method of claim 2, wherein the capture image and the moving photograph can be shared via at least one predetermined application.

7. A method of generating a moving photograph, comprising:
displaying any selected one of a plurality of stored photographs;
when any one of a plurality of moving effects is selected by a user, applying the selected effect to the selected photograph; and
generating a moving photograph in which the applied effect is moving in the selected photograph.

8. The method of claim 7, wherein applying the selected effect to the selected photograph comprises determining a location of the selected photograph to which the selected effect will be applied based on an object included in the selected photograph, and applying the selected effect to the determined location of application.

9. An apparatus for generating a moving photograph, comprising:
a display unit configured to display a subject photographed by a camera;
an application unit configured to, when any one of a plurality of moving effects is selected by a user, apply the selected effect to the displayed subject; and
a generation unit configured to capture the subject and the applied effect in compliance with a photographing command, and to generate a moving photograph in which the subject is maintained in a captured state and only the applied effect is moving.

10. The apparatus of claim 9, wherein the generation unit is further configured to:
capture the subject and the applied effect at a time at which the photographing command is received, generate a capture image, and provide the generated capture image to the display unit so that the generated capture image can be displayed; and
when a button formed in a partial area of the displayed capture image is selected by the user, generate the moving photograph from the capture image.

11. The apparatus of claim 9, further comprising a storage unit configured to, when a storage button configured to store the generated moving photograph is selected by the user in a state in which the generated moving photograph has been displayed on the display unit, store the moving photograph in a Graphics Interchange Format (GIF) file.

12. The apparatus of claim 9, wherein the application unit is further configured to determine a location of the subject to which the selected effect will be applied based on an object included in the subject and to apply the selected effect to the determined location of application.
